(19) United States
(12) Patent Application Publication
(10) Pub. No.: US 2015/0124073 A1
(43) Pub. Date: May 7, 2015

(54) ILLUMINATION OPTICAL SYSTEM AND MICROSCOPE

(71) Applicant: CANON KABUSHIKI KAISHA, Ohta-ku, Tokyo (JP)

(72) Inventors: Hironobu Fujishima, Saitama-shi (JP); Hideki Morishima, Utsunomiya-shi (JP); Hiroshi Matsuura, Utsunomiya-shi (JP)

(21) Appl. No.: 14/397,345

(22) PCT Filed: Aug. 29, 2013
(86) PCT No.: PCT/JP2013/073857

§ 371 Date: Oct. 27, 2014

(30) Foreign Application Priority Data
Aug. 29, 2012 (JP) 2012-188223
Aug. 26, 2013 (JP) 2013-174742

(51) Int. Cl. G02B 21/16; G02B 21/36; G02B 21/00; G02B 21/06

(52) U.S. Cl. CPC G02B 21/16; G02B 21/06; G02B 21/361; G02B 21/0092
USPC 348/79; 359/385

(57) ABSTRACT

The illumination optical system is configured to illuminate a sample placed on an object plane with light. The illumination optical system includes multiple light source areas which are mutually coherent and arranged separately from one another in a pupil plane of the illumination optical system. Among distances from a center of a pupil of the illumination optical system to centers of the multiple light source areas, at least one of the distances is different from the other distances.

### TECHNICAL FIELD

The present invention relates to an illumination optical system that illuminates a sample with light in a microscope, particularly to an illumination optical system suitable for a three-dimensional fluorescence microscope.

### BACKGROUND ART

Observation of biological samples using microscopes, particularly a fluorescence microscope, is essential for biological studies including application to medicine. However, when a thick sample is observed by a general (or normal) fluorescence microscope, an image is observed which is formed by superimposition of images at all height positions of the sample through which light is transmitted. That is, an image of a height position plane (in-focus plane) on which the microscope is focused and defocused images of height position planes (out-of-focus plane) on which the microscope is not focused are superimposed and observed. Thus, in the general fluorescence microscope, it is not possible to selectively separate and extract only images of a desired in-focus plane. An effect of selectively separating and extracting only the images of the desired in-focus plane is referred to as “a sectioning effect”.

A fluorescence microscope configured to obtain the sectioning effect on the basis of a variety of mechanisms is called a three-dimensional fluorescence microscope, and is distinguished from general fluorescence microscopes. The sectioning effect enables producing a stereoscopic three-dimensional image by rendering images of arbitrary in-focus planes on a computer. That is, digital processing enables anyone to perform stereoscopic view of cell structure, which has been performed in a brain by an experienced pathologist or the like so far.

As a typical three-dimensional fluorescence microscope, a confocal microscope is used. The confocal microscope has a pinhole placed at a convergence point of light coming from a desired in-focus plane to allow passage of only the light coming from the desired in-focus plane and shield light of a low convergence degree coming from the out-of-focus planes. This confocal microscope has a high sectioning effect, but only captures at one image capturing a point-like narrow area, so that scanning is needed in order to capture (observe) the entire area of the sample.

Meanwhile, as a method for realizing the sectioning effect by utilizing image processing by the computer, a structured illumination method (see NPL 1) is used.

This method produces, for example, sinusoidal illumination intensity patterns on an object. The intensity patterns are similar figures but are given different initial phases. This method captures multiple images each corresponding to these phases.

Then, the method causes the computer to perform the image processing on the multiple images to obtain the sectioning effect. Such a structured illumination method requires producing the phase with high accuracy, that is, producing the sinusoidal structure whose position is controlled.

Furthermore, a method in which a speckle pattern randomly generated is utilized as illumination is also used (see PTL 1 and NPL 2, NPL 3, NPL4, NPL 5 and NPL 6). Although this method also uses the image processing by the computer, since the illumination intensity on the object plane depends on the random speckle pattern, the method has an unavoidable disadvantage that non-uniform intensity unevenness remains in a final image.

### CITATION LIST

### Patent Literature

[PTL 1] U. S. Patent Application Publication No. 2010/0224796

### Non Patent Literature

[NPL 1] M. A. A. Neil and T. Wilson, “Method of obtaining optical sectioning by using structured light in a conventional microscope,” Opt. Lett. 22, 1905 (1997).
[NPL 2] C. Ventalon and J. Mertz, “Quasi-confocal fluorescence sectioning with dynamic speckle illumination,” Opt. Lett. 30, 3350-3352 (2005).
[NPL 3] C. Ventalon and J. Mertz, “Dynamic speckle illumination microscopy with translated versus randomized speckle patterns,” Opt. Express 14, 7198-7209 (2006).
[NPL 4] C. Ventalon, R. Heintzmann, and J. Mertz, “Dynamic speckle illumination microscopy with wavelet prefiltering,” Opt. Lett. 32, 1417-1419 (2007).
[NPL 5] Daryl Lim, Kengyeh K. Chu, and Jerome Mertz,“Wide-field fluorescence sectioning with hybrid speckle and uniform-illumination microscopy,” Opt. Lett. 33, 1819-1821 (2008).
[NPL 6] Daryl Lim, N. Ford, Kengyeh K. Chu, and Jerome Mertz,“Optically sectioned in vivo imaging with speckle illumination HiLo microscopy” Journal of Biomedical Optics. 16, 016014 (2011).

### SUMMARY OF INVENTION

### Technical Problem

Thus, it is desired to develop a three-dimensional fluorescence microscope capable of providing a high quality sectioning effect without requiring highly controlled illumination system and scanning of an object plane.

### Solution to Problem

The present invention provides an illumination optical system suitable for realizing such a three-dimensional fluorescence microscope.

The present invention provides as one aspect thereof an illumination optical system configured to illuminate a sample placed on an object plane with light. The illumination optical system includes multiple light source areas which are mutually coherent and arranged separately from one another in a pupil plane of the illumination optical system. Among distances from a center of a pupil of the illumination optical system to centers of the multiple light source areas, at least one of the distances is different from the other distances.

The present invention provides as another aspect thereof a microscope including the above illumination optical system, and a projection optical system configured to form an image of the sample.

### Advantageous Effects of Invention

Using the illumination optical system of the present invention enables achieving a three-dimensional fluorescence microscope capable of providing a high quality sectioning effect without requiring highly controlled illumination system and scanning of an object plane.

### BRIEF DESCRIPTION OF DRAWINGS

FIGS. 1A and 1B show an object O that is uniformly illuminated.

FIGS. 2A and 2B show the object O that is subjected to speckle illumination.

FIGS. 3A and 3B show a difference between FIGS. 1 and 2.

FIG. 4 schematically shows an area for calculating a spatial dispersion value of intensity, which are near points (x, y) of FIG. 3.

FIG. 5 shows non-uniformity in an x-y direction of 6 (x, y, z).

FIG. 6A shows an example of a pupil function for realizing a comb function illumination light intensity distribution.

FIG. 6B shows an actual illumination light intensity distribution obtained when that pupil function is used.

FIG. 7 shows an illumination light intensity distribution obtained in a plane of z=±2 μm in a sample when an illumination optical system having the pupil function of FIG. 6A is used.

FIG. 8 shows a fluorescence intensity distribution observed in a plane of z=0 μm in the sample when illuminating an object O2 using the illumination optical system having the pupil function FIG. 6A.

FIG. 9A shows a pupil function P2 in Embodiment 1 of the present invention.

FIG. 9B shows an illumination light intensity distribution in a plane of z=0 μm in a sample when an illumination optical system having the pupil function P2 is used.

FIG. 10 shows a fluorescence intensity distribution observed in the plane of z=0 μm in the sample when illuminating the object O2 using the illumination optical system having the pupil function of FIG. 9A.

FIG. 11 is a schematic view showing an arrangement example in a three-dimensional fluorescence microscope using the illumination optical system of the embodiment. FIGS. 12A to 12D show an image of the object O2 obtained by using a random speckle illumination disclosed in NPL 5 and NPL 6.

FIGS. 13A to 13D show an image of the object O2 obtained by using a lattice illumination formed by the illumination optical system of Embodiment 1 having the pupil function P2.

FIGS. 14A and 14B show a pupil function including two light source points in Embodiment 2 of the present invention and an illumination light intensity distribution in a plane of z=0 μm in a sample when using an the illumination optical system having that pupil function.

FIGS. 15A to 15D show images of the object O2 obtained by using a fringe illumination formed by the illumination optical system of Embodiment 2 having the pupil function including two light source points.

FIG. 16 shows the pupil function of the embodiment.

FIG. 17 shows a general microscope.

FIG. 18 shows an illumination unit (illumination optical system) that is Embodiment 3 of the present invention.

FIG. 19 shows a configuration of the illumination unit of Embodiment 3 using three light beams.

FIG. 20 shows an illumination unit that a modified example of Embodiment 3.

FIG. 21 shows an illumination unit that another modified example of Embodiment 3.

FIGS. 22A and 22B schematically show a light-shielding member in Embodiment 4 of the present invention. FIGS. 23A and 23B schematically show Embodiment 5 of the present invention.

### DESCRIPTION OF EMBODIMENTS

Hereinafter, embodiments of the invention will be described with reference to the drawings.

A microscope illumination optical system of each embodiment of the present invention can be used for a three-dimensional microscope that is used for observation of a sample, such as a autoluminescent whose illuminance mechanism is fluorescence or phosphorescence. The microscope of each embodiment can be used as an epi-illumination microscope and a transmission microscope.

As a specific example, the microscope illumination optical system of each embodiment can be used for a microscope included in a digital slide scanner that is used for observation of a fluorescently stained sample serving as a test sample. The digital slide scanner is an apparatus that scans a preparation used in biological and pathological inspections and the like at high speed and converts scanned images of the preparation into high-resolution digital image data. Furthermore, the microscope illumination optical system of each embodiment can be used, for example, as a sectioning effect provider to provide the sectioning effect to the digital slide scanner including a projection optical system having a large numerical aperture (NA) and to a general fluorescence microscope.

Prior to a detailed description of the microscope illumination optical system of each embodiment, description will be made of problems in the conventional illumination method using the speckle pattern.

NPL 5 and NPL6 disclose a method of extracting only an image of a fluorescent object existing in an in-focus plane by using an image 1 captured under uniform intensity illumination and an image 2 captured under illumination by the speckle pattern. This method first produces an image 3 representing an intensity difference between the image 1 and the image 2 by a computer. Illumination of the object with the speckle pattern can be realized by inserting an optical element such as a frosted glass, which provides a random phase disturbance, into a pupil of an illumination optical system having a light source that emits a coherent excitation light. For simplification of the following description, an intensity distribution of the fluorescent object is defined as O(x, y, z), and an intensity distribution of O(x, y, z)=δ(z) is considered. In the following description, the intensity distribution of the fluorescent object O(x, y, z) is also referred to as “an object O”. The object O is a virtual object that exists only in the plane of z=0 and has a uniform intensity distribution in an x-y direction; the plane of z=0 is referred to as “an in-focus plane”. Moreover, a plane of z=±a (a>0) is representatively referred to as “an out-of-focus plane.”

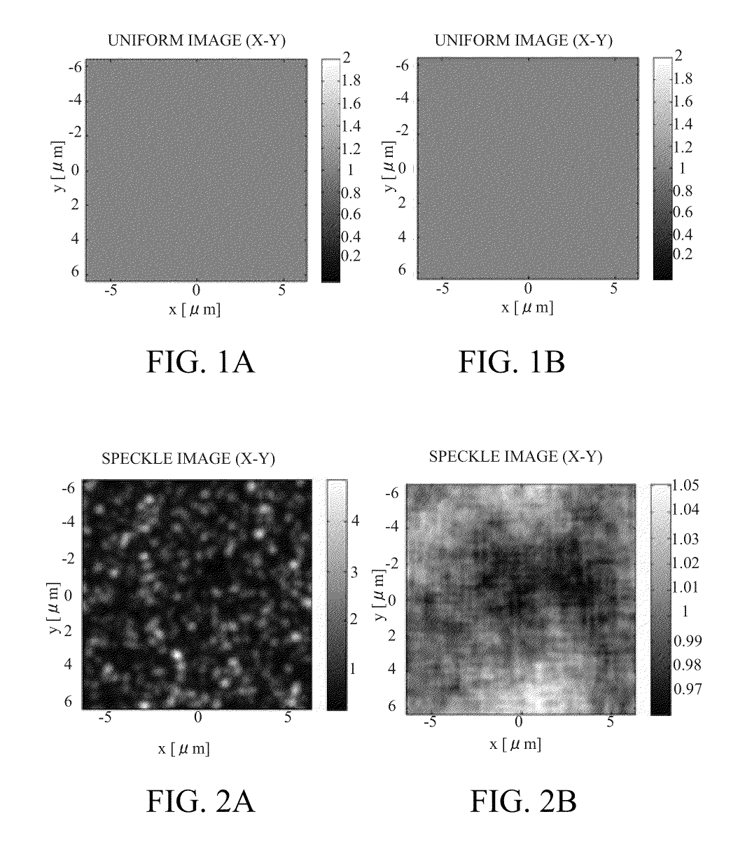

FIG. 1A shows an image obtained when the object O is illuminated with a uniform intensity distribution and observed by focusing on the in-focus plane. The image captured under the illumination having the uniform intensity distribution is defined as Is(x, y, z). Moreover, FIG. 1B shows an image obtained when the object O is illuminated under the same illumination and observed by focusing on the out-of focus plane. These images correspond to the above-mentioned image 1.

On the other hand, FIG. 2A shows an image obtained when the object O is illuminated with the speckle pattern and observed by focusing on the in-focus plane. FIG. 2B shows an image obtained when the object O is illuminated with the same illumination and observed by focusing on the out-of focus plane. These images correspond to the above-mentioned image 2.

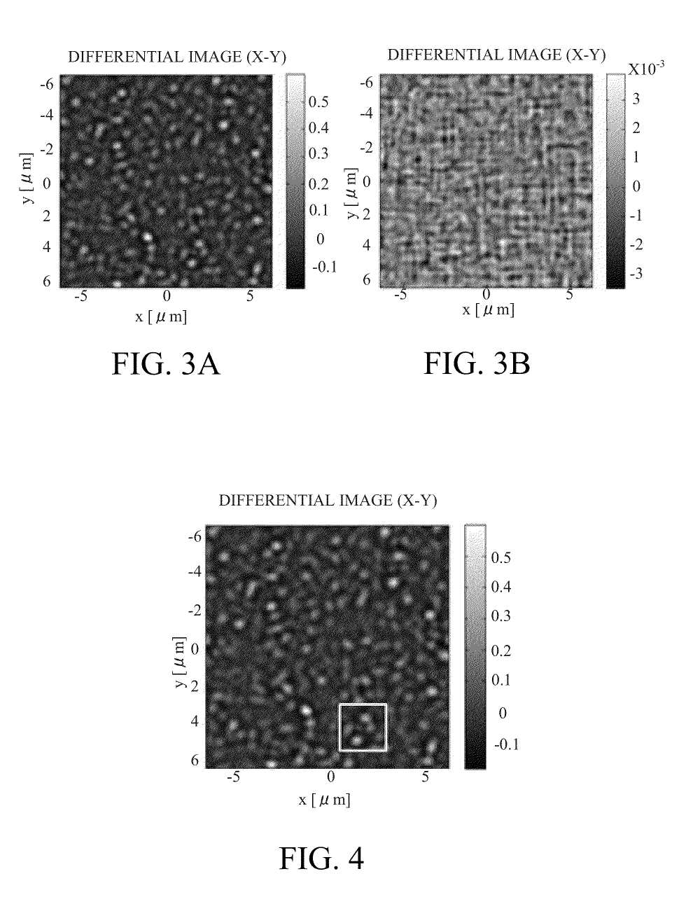

Furthermore, FIG. 3A shows an image showing a difference between the intensity distribution of the image shown in FIG. 1A and the intensity distribution of the image shown in FIG. 2A. FIG. 3B shows an image showing a difference between the intensity distribution of the image shown in FIG. 1B and that of the image shown in FIG. 2B. These images correspond to the above-mentioned image 3.

As is clear from FIGS. 1A and 1B, when performing image capturing with a general uniform illumination, the image obtained by focusing on the in-focus plane (z=0) where the object O actually exists and the image obtained by focusing on the out-of-focus plane (z=±a (a>0)) where the object O does not actually exist are entirely identical to each other and thus indistinguishable. Therefore, it is understood that general (or normal) fluorescence microscopes do not have the sectioning effect.

NPL 5 and NPL 6 disclose a method of extracting, from data of these images 3, data that reflects the intensity distribution O(x, y, z) of the actual fluorescent object. Specifically, a computer takes in the images shown in FIGS. 3A and 3B, and calculates a spatial standard diviation σ of an intensity difference in a region near points (x, y) (that is, a region indicated by a white frame in FIG. 4). Moreover, the computer produces a map σ(x, y, z) of the standard deviation thus obtained. As can be easily imagined from FIGS. 3A and 3B, the image shown in FIG. 3A corresponding to an image obtained by processing light from the in-focus plane has a sharp black and white contrast, so that σ(x, y, 0) becomes a high value. On the other hand, the image shown in FIG. 3B corresponding to an image obtained by processing light from the out-of-focus plane has little contrast due to blur of a speckle image. For this reason, the map σ(x, y, a) has a value almost uniformly close to 0.

Therefore, calculating I(x, y, z) by using following expression (1) provides an image I(x, y, z) that acquires the sectioning effect by σ(x, y, z). That is, I(x, y, 0) has a certain value, but I(x, y, a) has little value.

I(x,y,z)=Iu(x,y,z)·σ(x,y,z) (1)

In expression (1), Iu(x, y, z) represents an image captured such that a position of a height of z is in focus and the general uniform illumination is performed. The image that acquires the sectioning effect is hereinafter referred to also as “a sectioning image”.

In this way, an image close to the actual object O can be reconstructed by the computing. However, this method naturally uses, as the illumination of the object, a speckle phenomenon that is a random phenomenon, which includes an unavoidable defect described below.

Originally expected I(x, y, 0) is Iu(x, y, 0) uniform in the x-y direction as shown in FIG. 1A. That is, σ(x, y, 0) is also expected to be uniform in the x-y direction. In practice, however, FIG. 5 shows that σ(x, y, 0) never becomes uniform in the x-y direction. This is a so-called illumination unevenness due to a fact that the speckle pattern does not have a uniform distribution, which may significantly degrade the image quality of the final I(x, y, 0).

Hence, this embodiment provides an illumination method having the sectioning effect while preventing the image quality degradation due to the illumination unevenness. A principle thereof will hereinafter be described.

This embodiment is based on the following mathematical facts. Generally, a function represented by expression (2) is referred to as “a comb function”.

Comb(x,y)==Σδ(x−mp)≦(y−np)

In expression (2), δ represents a Dirac delta function, and p represents an interval (pitch) between infinite valued points in a direction of a coordinate axis. In addition, Σ represents a sum symbol in which m and n are integers of −∞<m and n<∞.

The mathematical facts concerning the comb function is that, as represented in expression (3), the Fourier transform of itself thereof also becomes a comb function in which a pitch is 1/p.

F[comb(x,y)](f,g)=Σδ(f−m/p)δ(g−n/p) (3)

In expression (3), F represents the Fourier transform. Moreover, f and g represent spatial frequencies corresponding to x and y, respectively.

Generally, performing the Fourier transform on an amplitude distribution P(f, g) (pupil function) in a pupil of an optical system provides an amplitude distribution in an image plane of the optical system. In a case where the optical system is an illumination optical system, a square absolute value of the amplitude distribution in the image plane is an intensity distribution of light that illuminates a sample object. Thus, setting P(f, g) of the illumination optical system to the comb function achieves a comb function-like illumination light. The comb function-like illumination light provides illumination lights each having a uniform intensity distribution at a uniform pitch on the object plane, which may not cause the illumination unevenness.

NPL 5 and NPL 6 disclose that a smaller pitch of the illumination light on the object plane further reduces size of a calculation region of σ shown in FIG. 4 and thereby resolution performance in a horizontal direction is improved. Therefore, it is desirable that a pitch on a pupil plane of an illumination optical system be large as much as possible. In practice, since the pupil of the optical system has only a limited size, it is impossible to achieve an illumination that continues infinitely in an f−g direction as represented by expression (3). However, only employing a minimal structural unit of the comb function as an amplitude distribution on the pupil plane makes it possible to achieve an illumination without illumination unevenness.

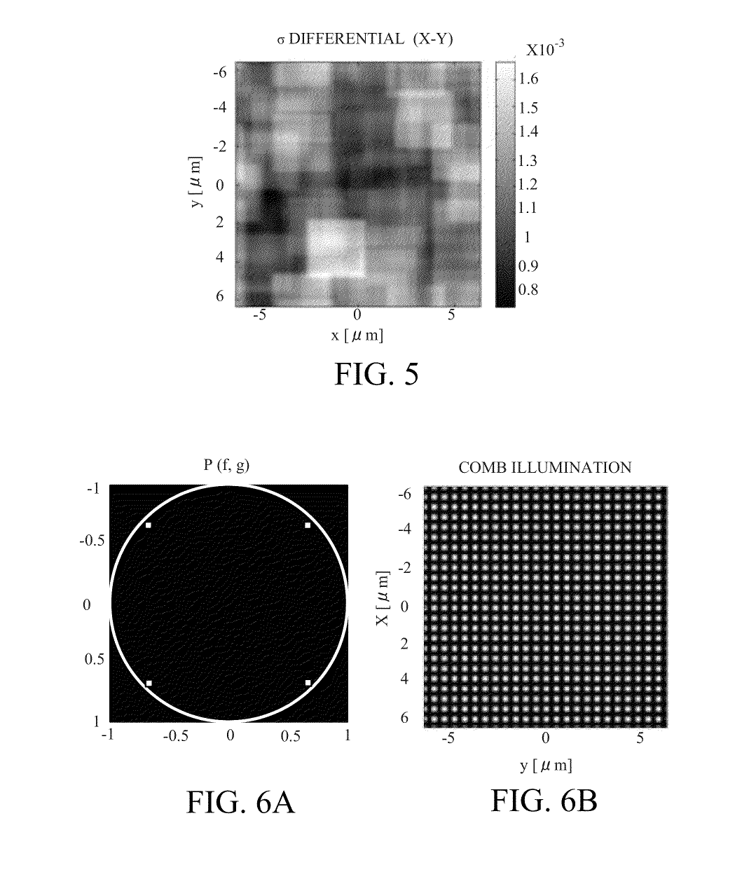

Such an illumination without illumination unevenness is shown in FIGS. 6A and 6B. FIG. 6A shows the illumination that employs as P (f, g) a minimum square expressed in the comb function expressed by expression (2). FIG. 6B shows illumination intensity obtained on the object plane by that illumination. In the illumination of FIGS. 6A and 6B, a use wavelength λ, is 500 nm, and a numerical aperture NA is 0.7. When the pupil of the illumination optical system is normalized with a radius of 1, coordinates of positions having amplitude are as follows:

(1/√2,1/√2);

(−1/√2,1/√2);

(−1/√2,−1/√2); and

(1/√2,−1/√2).

Using the method of calculating σ(x, y, 0) described above for the object illuminated by the periodic illumination light as shown in FIG. 6B enables, because of no illumination unevenness, provision of σ(x, y, 0) having very high uniformity.

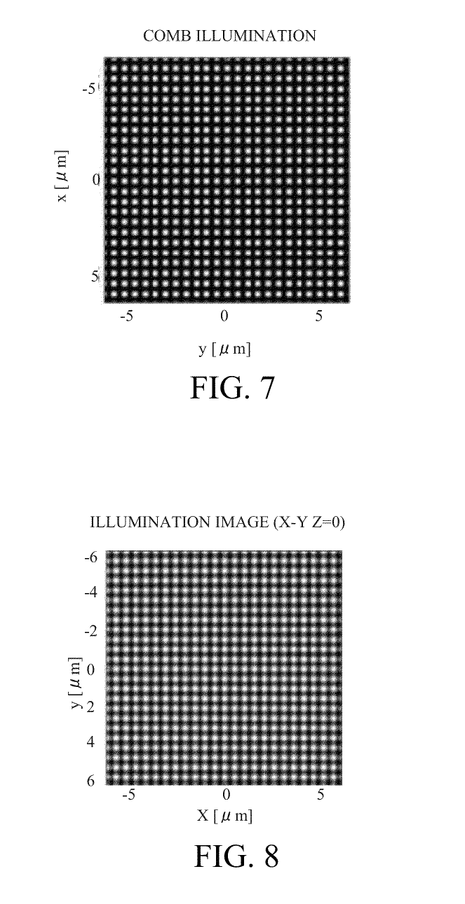

However, there is a significant defect in the illumination shown in FIG. 6A. It is known that, when using the pupil function P (f, g) of such an illumination optical system, an illumination distribution at a position away from the image plane (that is, the object plane) has almost no blur, as shown in FIG. 7.

FIG. 7 shows a distribution of the illumination light at positions of z=±2.0 μm. As understood from comparison of FIG. 7 with FIG. 6B, it is understood that the illumination light has no blur. In order to describe a thing becoming a problem under such a situation, an object O2(x, y, z)=δ(z+1)+δ(z−1) is defined where a unit of z is μm.

When an image of the object O2 is captured, of course, the final image should not have intensity at z=0. Even if the final image has certain intensity, it is necessary that the intensity be very lower than those of the images at z=±1.

Consider that the pupil function shown in FIG. 6A is used to illuminate the object O2 comprising an upper fluorescent object located at the position of z=1 and a lower fluorescent object located at the position of z=−1. The resultant illumination intensity distributions at z=1 and z=−1 planes are almost the same since the pupil function shown in FIG. 6 (a) generates almost blur-free illumination intensity distribution.

Therefore, a comb function-like fluorescent light coming from the upper fluorescent object exactly overlaps a comb function-like fluorescent light coming from the lower fluorescent object at the position of z=0, and thereby a light intensity distribution having a very high contrast is formed at z=0. FIG. 8 shows the light intensity distribution formed at z=0. As described above, the high contrast maintains the value of σ(x, y, 0) at a high value, which results in a false image at the position of z=0 where the object O2 does not really exist.

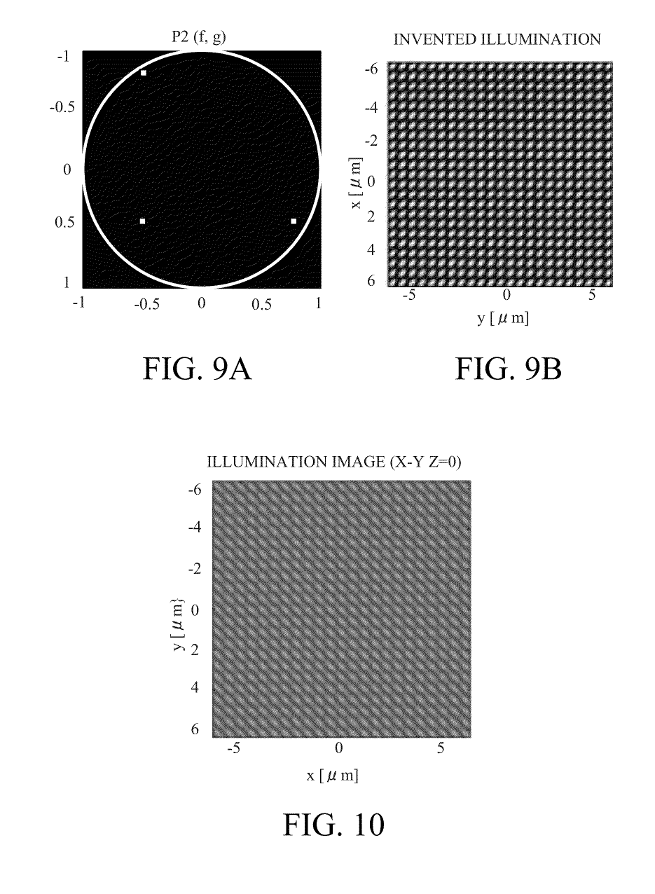

Hence, this embodiment uses, the pupil function P2(f, g) shown in FIG. 9A to solve this problem, instead of using the pupil function (amplitude distribution) P(f, g) shown in FIG. 6A The pupil function P2(f, g) is characterized in that, in an orthogonal coordinate system on the pupil plane (the pupil is normalized with the radius of unity) of the illumination optical system, mutually coherent point light sources are arranged in the pupil at three points expressed by following coordinates (A) or three vertices of a triangle similar to a triangle formed by the three points.

(−1/√2+a,1/√2+b);

(−1/√2+a,−1/√2+b); and

(1/√2+b,−1/√2+a) (A)

In the coordinates, a and b represent real numbers.

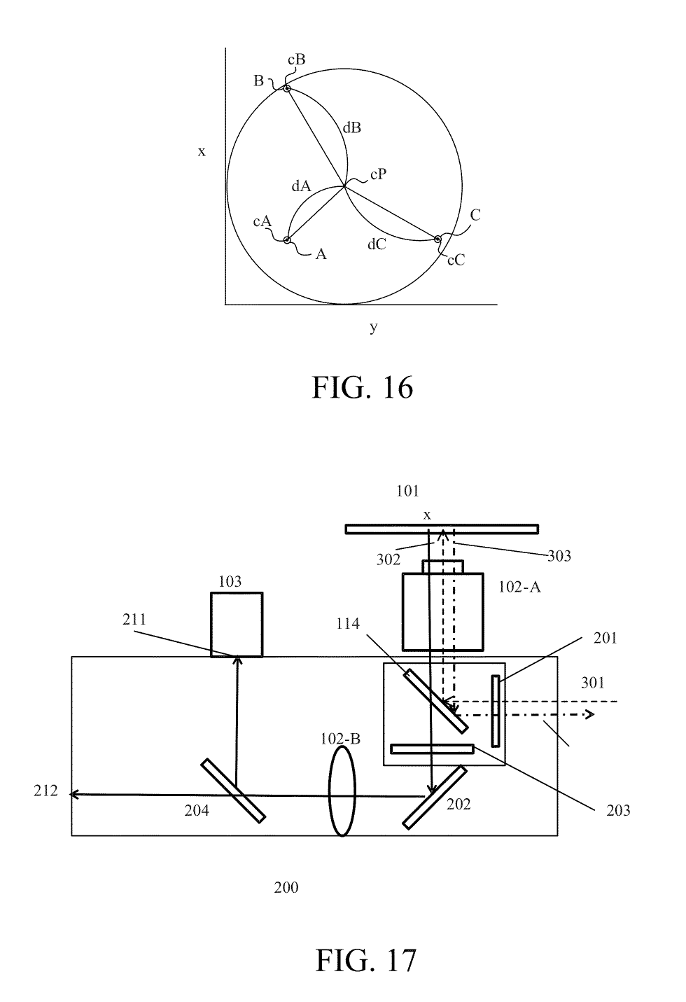

In other words, in the pupil function P2(f, g), as shown in FIG. 16, multiple light source areas A, B and C which are mutually coherent are arranged separately from each other in the pupil plane of the illumination optical system. Moreover, among a distance dA between a center cA of the light source area A and a center of the pupil of the illumination optical system, a distance dB between a center cB of the light source area B and the center of the pupil and a distance dC between a center cC of the light source area C and the center of the pupil, at least one distance is different from the other distances. The light source area includes also a point light source that can be regarded as having a minute area. Furthermore, it is desirable that the light source area be an area having a ratio of a size to the radius of the pupil less than 0.3. The expression “at least one distance is different from the other distances” means that all the distances are different from one another and only one distance is different from the other two distances which are mutually the same.

FIG. 9B shows a lattice illumination light intensity distribution on the object plane that can be actually obtained using the pupil function (amplitude distribution) P2(f, g). Since an isosceles right triangle obtained by connecting the three points having amplitude on the pupil plane is also a repeating unit of the comb function, the illumination light intensity distribution formed thereby is also similar to the illumination intensity shown in FIG. 6B. Although each spot of the illumination light has a shape slightly close to an oval shape, there is no illumination unevenness at all. An effect of P2 intentionally arranging the multiple coherent light sources asymmetrically with respect to an origin as the center of the pupil appears in a lateral shift of the intensity distribution of the illumination light with change of z because of oblique incidence of the illumination light.

In order to verify this effect, a situation will be described in which the upper fluorescent object located at the position of z=1 and the lower fluorescent object located at the position of z=−1 are illuminated with mutually displaced illuminations formed by P2, respectively. In this situation, the overlap of the fluorescent lights coming from the upper and lower fluorescent objects at the position of z=0 with a displacement (imperfect overlap thereof) forms a light intensity distribution having a very low contrast as shown in FIG. 10.

As understood from comparison of FIG. 10 with FIG. 8, the contrast is much lower in FIG. 10, and therefore this embodiment can suppress the false image at z=0 from being unnecessarily resolved.

Using the illumination method (that is, the illumination optical system) of this embodiment described above with the methods disclosed in NPL 5 and NPL 6, enables provision of a good image without intensity unevenness without performing scanning that requires a long time.

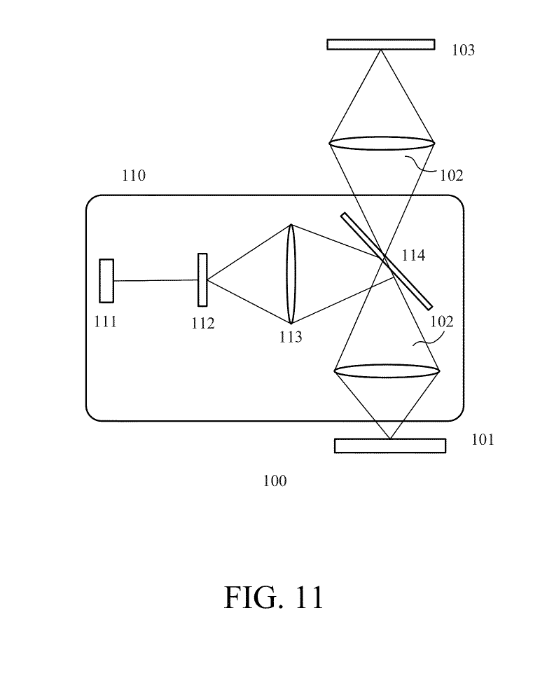

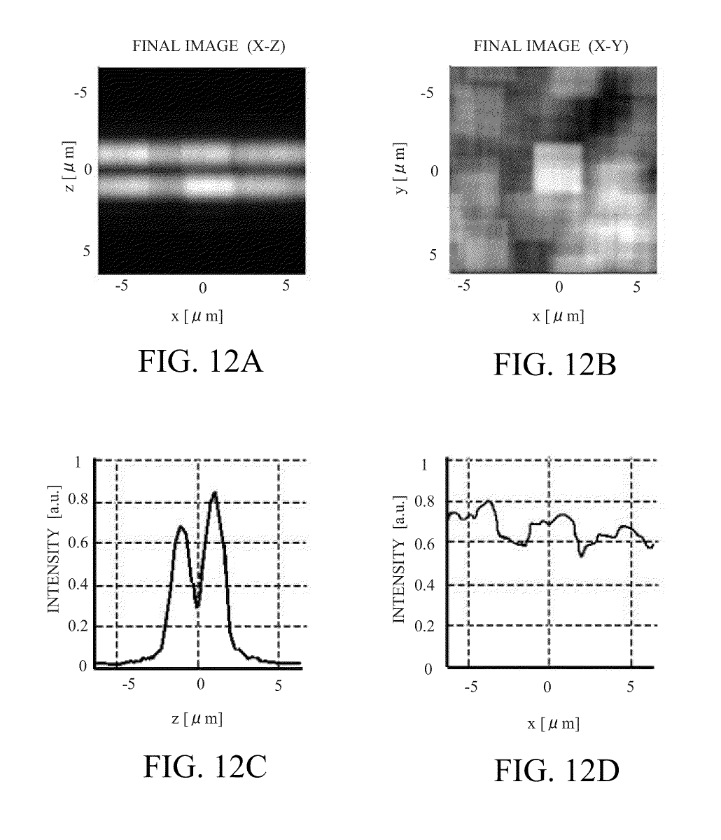

Next, description will be made of a preferred arrangement example of the illumination optical system of this embodiment in the three-dimensional fluorescence microscope with reference to FIG. 11. In FIG. 11, reference numeral 100 denotes an epi-illumination three-dimensional fluorescence microscope.

Reference numeral 110 denotes an illumination optical system which has a configuration capable of being added to a microscope body constituted by an objective lens 102 and an image sensor 103. Reference numeral 101 denotes an object (sample) placed on an object plane.

In the illumination optical system 110, reference numeral 111 denotes a coherent light source constituted by a laser or the like which emits light of a wavelength for exciting a fluorescent sample. Reference numeral 112 denotes an optical element, such as a diffraction grating, a prism or an optical fiber, and has a function of dividing one light beam emitted from the light source 111 into multiple (for example, three) light beams. The optical element 112 is not limited to the diffraction grating, the prism or the like, and may be any other element as long as it is capable of realizing the pupil function shape characterized in this embodiment with respect to a pupil plane 113 of the illumination optical system 110. The pupil function shape in this embodiment can be realized by easy methods for engineers concerning microscopes or semiconductor exposure apparatuses, such as computer-generated hologram (CGH).

The divided light beams are reflected by a dichroic mirror 114 and pass through the objective lens (objective optical system) 102 to illuminate the object 101 with a lattice illumination light intensity distribution. Fluorescent light emitted from the object 101 passes through the objective lens 102, passes through the dichroic mirror 114 and then passes through another objective lens 102 to be imaged on the image sensor 103. An image captured by the image sensor 103 and displayed on a monitor (not shown) is observed by an observer.

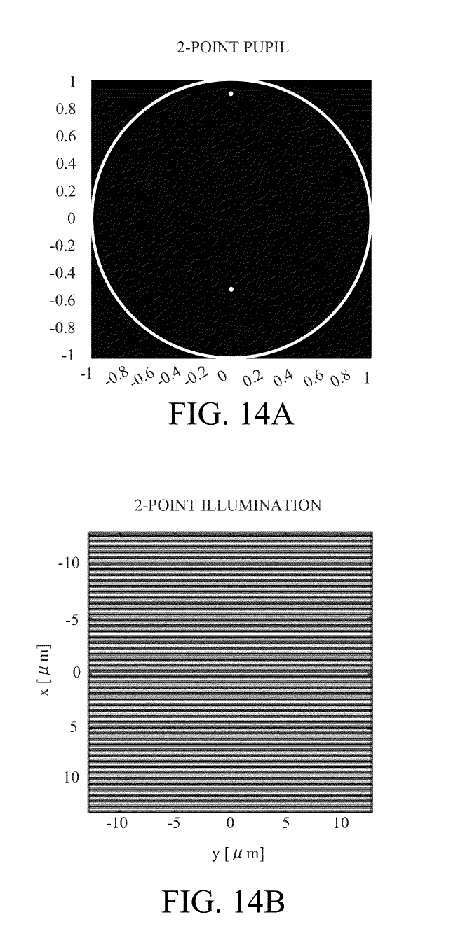

Although the number of point light sources in the pupil of the illumination optical system was three in the above description, the number thereof is not limited to three. When the three point light sources are provided, three light beams having incident angles respectively corresponding to positions of the three point light sources are projected onto the object 101 and thereby a lattice-like pattern shown in FIG. 9B is formed. As described in detail in Embodiment 2 below, a method equivalent to that described above can be implemented without problem. When providing two point light sources as an amplitude distribution P(f, g) on the pupil plane of the illumination optical system, an intensity distribution forming a stripe pattern is generated on the object 101 as shown in FIG. 14B. Since the two point light sources are arranged asymmetrically with respect to the center of the pupil as shown in FIG. 14A, change of a focus coordinate z causes lateral shift of the stripe pattern intensity distribution. This is similar to the above-described case of providing the three asymmetric point light sources. Therefore, setting the two point light sources asymmetrically with respect to the pupil center also enables providing a good sectioning image without illumination unevenness as well as the case of setting the three asymmetric point light sources. Hereinafter, various intensity patterns of the illumination light obtained by arranging multiple mutually coherent light source areas separately from one another in the pupil plane of the illumination optical system and arranging such that, among the distances from the pupil center of the illumination optical system to the centers of the multiple light source areas, at least one of the distances is different from the other distances are collectively referred to as “an asymmetric structure illumination”.

The outline of the embodiment of the present invention was described above. Installing an illumination unit (illumination optical system) of the embodiment capable of realizing both the asymmetric structure illumination and the illumination having a uniform intensity distribution to a general fluorescence microscope enables constructing a three-dimensional fluorescence microscope system capable of providing a high-quality sectioning effect. Moreover, the illumination unit can be realized only by performing a simple and easily restorable modification on the general fluorescence microscope. Description will be made of this illumination unit below.

In order to realize the three-dimensional fluorescence microscope, it is necessary to acquire by image capturing (a) an image 1 of a fluorescent sample illuminated with an excitation light having a uniform intensity distribution (the excited light is hereinafter referred to also simply as “a uniform illumination”) and (b) an image 2 of the fluorescent sample illuminated with the asymmetric structure illumination.

First, description is made of a configuration and an illumination method of the illumination unit realizing the asymmetric structure illumination. The image of the fluorescent sample (hereinafter referred to also as “a fluorescent image”) is acquired by using an image sensor such as a CCD sensor or a CMOS sensor. Since general fluorescence microscopes have multiple camera ports, the following description is made on an assumption that the three-dimensional fluorescence microscope of the embodiment has multiple camera ports. Moreover, since an ocular observation system does not have an essential role in the three-dimensional fluorescence microscope described below, its description (and drawings) is omitted.

FIG. 17 schematically shows the configuration of the general fluorescence microscope 200. In the following description, common components are denoted by common reference numerals. In addition, components each having an identical function are basically denoted by common reference numerals. An excitation light 301 (shown by a dotted line) from an excitation light source (not shown) such as a mercury lamp or a laser is introduced to inside of the general fluorescence microscope 200, passes through an excitation light filter 201 to be converted into a light beam of a predetermined wavelength band and then reaches a dichroic mirror 114. The dichroic mirror 114 reflects a light of a shorter wavelength than an approximately intermediate wavelength between an exciting wavelength of the fluorescent sample and a wavelength of a fluorescent light and transmits a light of a longer wavelength than the approximately intermediate wavelength. Therefore, the excitation light 301 is reflected by the dichroic mirror 114, passes through an objective lens 102-A and then is projected onto the object 101. A fluorescent light 302 (shown by a solid line) emitted from the object 101 and the excitation light 303 (shown by a dashed-dotted line) reflected and scattered by the object 101 pass through the objective lens 102-A and then reach the dichroic mirror 114. Most of the fluorescence light 302 is transmitted through the dichroic mirror 114 and then reaches a fluorescent light filter 203, and, on the other hand, most of the excitation light 303 reflected and scattered by the object 101 is reflected by the dichroic mirror 114.

Inmost general fluorescence microscopes, the excitation light filter 201, the dichroic mirror 114 and the fluorescent light filter 203 are combined as one unit and rotatably detachably (interchangeably) attached via a turret. The fluorescence light 302 transmitted through the fluorescent light filter 203 is reflected by a bending mirror 202, passes through an imaging lens 102-B and enters a half mirror 204 to be divided into two light beams. One of the two light beams is introduced to a first camera port 211 to be imaged on and image sensor 103 such as a CCD sensor disposed thereat, and the other one of the two light beams reaches a second camera port 212. The first and second camera ports 211 and 212 are arranged at position conjugate with the object 101, and an imaging surface of the image sensor 103 is disposed on a plane conjugate with the object 101. A plane optically conjugate with the object 101 which is located inside each of the first and second camera ports 211 and 212 is hereinafter referred to as “an in-camera port conjugate plane.”

Most recent microscopes including the general fluorescence microscopes employ an infinity correction method, and thereby the fluorescent light from the sample is converted into a collimated light flux by the objective lens and propagates as the collimated light without change to the imaging lens to be collected by the imaging lens. Moreover, generally, the microscopes use a telecentric optical system for both image side and object side optical systems. Under the above conditions, in the microscopes employing the infinity correction method, focusing is made on the sample located at a front focal point of the objective lens and an image of the sample is formed at a rear focal point of the imaging lens. In addition, a rear focal point of the objective lens is coincided with a front focal point of the imaging lens. Furthermore, the in-camera port conjugate plane is coincided with the rear focal point in an optical axis direction.

In order to realize the asymmetric structure illumination on the object, it is necessary to divide the excitation light into multiple mutually coherent light beams respectively having predetermined incident angles and to produce an interference region where the multiple light beams overlap one another on the object plane. Hereinafter the mutually coherent light beams are referred to also simply as “light beams”.

When realizing such an asymmetric structure illumination in the existing general fluorescence microscopes, where the excitation light is introduced from is a problem. However, in the above-mentioned general fluorescence microscopes having the camera ports, the conjugate relation between the in-camera port conjugate surface and the object plane can be utilized.

In particular, a configuration can be employed in which the image sensor 103 such as a CCD sensor is disposed at the first camera port 211 and the excitation light as the divided multiple light beams for the asymmetric structural illumination is introduced from the second camera port 212. This configuration can introduce the excitation light as the divided multiple light beams into the microscope from the second camera port 212, causes the excitation light to proceed along an optical path (the imaging lens 102-B, the objective lens 102-A and the object 101) that is reverse to a normal imaging optical path for the object 101, and then projects the excitation light onto the object 101. Since the camera port and the sample are arranged at conjugate positions, if the introduced multiple light beams overlap one another on the in-camera port conjugate plane, they also overlap one another on the object plane and interfere with one another, which secures realization of the asymmetric structure illumination.

A pattern pitch of the asymmetric structure illumination is decided depending on the incident angles of the multiple light beams on the object plane. Each of these incident angles can be defined by an angle formed by each light beam entering the camera port with respect to the optical axis. Specifically, when m represents an imaging magnification of the object with respect to the in-camera port conjugate plane and θ₂ represents the incident angle of each light beam on the object plane, the incident angle θ₁ formed by each light beam entering the camera port with respect to the optical axis can be decided such that the following relation is satisfied:

sin θ₁=sin θ₂/m.

Next, description will be made of optical properties of the excitation light entering the object. Since it is necessary that the light source used for the asymmetric structure illumination is coherent, it is desirable to use a laser source as the light source. As the laser source, a semiconductor laser or a gas laser can be used which has an oscillation wavelength in an excitation wavelength region. As one of properties of the laser light, a beam waist is important. The beam waist is a portion of the laser light (laser beam) where its diameter (beam diameter) is minimum. In other words, the beam diameter of the laser beam increases from the beam waist forward and backward in its propagation direction.

Moreover, it is known that a curvature radius of a wavefront of the laser light becomes maximum (planar) at the beam waist. In order to reduce distortion of an intensity pattern of the asymmetric structure illumination, it is desirable that a wavefront of each of the above-mentioned multiple light beams be planer on the object surface. Therefore, it is desirable that, as the multiple light beams to form the asymmetric structure illumination, multiple laser beams each forming its beam waist on the object plane be used. The method for realizing the asymmetric structure illumination by using the general fluorescence microscope and the desirable conditions therein are as described above.

Next, description will be made of a configuration of the illumination unit producing the above-mentioned multiple light beams and modifications of the general fluorescence microscope necessary to install the illumination unit.

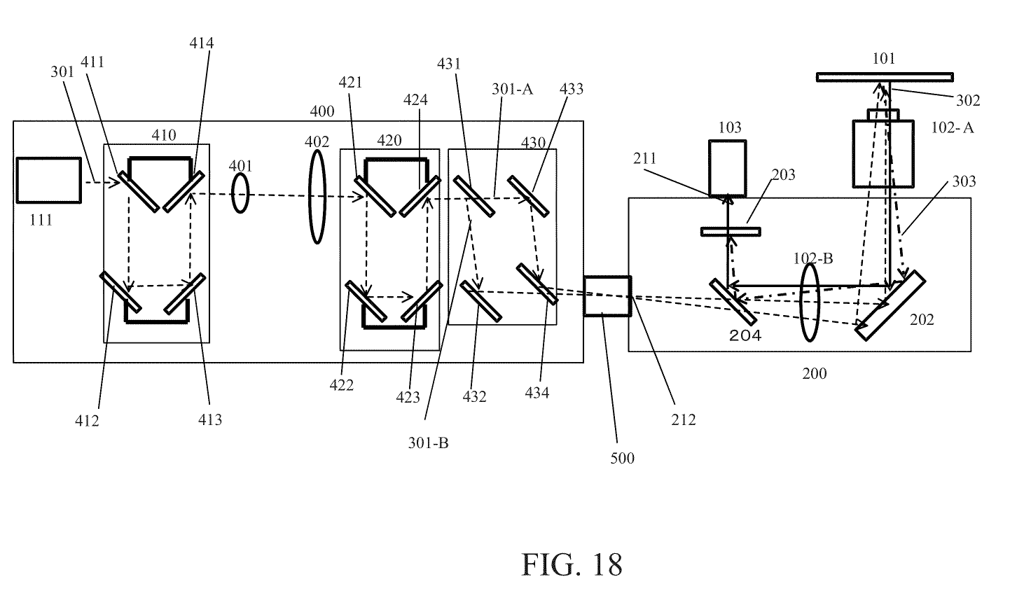

FIG. 18 schematically shows a three-dimensional microscope system configured by installing the illumination unit realizing the an asymmetric structure illumination to the general fluorescence microscope. As described above, the description (and drawings) of the ocular observation system is omitted. FIG. 18 exemplarily shows a case where two light beams as the multiple light beams project a stripe pattern onto the object plane. Reference numeral 400 denotes the illumination unit which is connected with the general fluorescence microscope 200 at the second camera port 212 via a mount member 500.

In the illumination unit 400, a laser source 111 is provided which emits a laser beam 301 (shown by a dotted line) to excite a fluorescent sample. The laser beam 301 enters a first optical path length adjuster 410. The first optical path length adjuster 410 is constituted by four bending mirrors 411 to 414. The laser beam 301 is reflected by the four bending mirrors 411 to 414 in this order and then enter a condenser lens 401. The laser beam 301 that has passed through the condenser lens 401 and a collimator lens 402 enters a second optical path length adjuster 420.

The second optical path length adjuster 420 is constituted by four bending mirrors 421 to 424. The laser beam 301 is reflected by the four bending mirrors 421 to 424 in this order and then enters a Mach-Zehnder interferometer 430. The later beam 301 entering the Mach-Zehnder interferometer 430 is subjected to intensity division to be divided by a half mirror 431 into two laser beams 301-A and 301-B. The laser beam 301-A is reflected by a bending mirror 433 and then reaches a half mirror 434. On the other hand, the laser beam 301-B is reflected by a bending mirror 432 and then reaches the half mirror 434.

Each of the two laser beams 301-A and 301-B is reduced in its intensity by the half mirror 434. Then, the two laser beams 301-A and 301-B pass through the mount member 500 and the second camera port 212 to enter the general fluorescence microscope 200. Subsequently, the two laser beams 301-A and 301-B pass through the half mirror 204 and the imaging lens 102-B, are reflected by the bending mirror 202 and then pass through the objective lens 102-A to reach the object 101. The half mirrors 431 and 434 and the bending mirrors 432 and 433 in the Mach-Zehnder interferometer 430 are each provided with an angle adjustment mechanism (not shown). The angle adjustment mechanism enables adjustment of the Mach-Zehnder interferometer 430 such that the two laser beams 301-A and 301-B overlap each other at the second camera port 212 and are projected onto the object surface at respective predetermined incident angles.

Next, description will be made of a desirable beam diameter of the beam waist formed on the object 101 and setting of parameters of the optical system to realize the desirable beam diameter.

The beam diameter on the object 101 decides an illumination area on the object 101; the illumination area should sufficiently cover an observation area. When f_{obj} represents a focal length of the objective lens 102-A and f_{tube} represents a focal length of the imaging lens 102-B, an imaging magnification m from the object 101 to the image sensor 103 is expressed as follows:

m=f_{tube}/f_{obj}.

When W_{image} represents half of a diagonal length of an effective image pickup area of the image sensor 103 and W_{obj} represents half of the effective image pickup area on the object 101, the following relation is established:

W_{obj}=W_{image}/m.

Accordingly, the beam diameter on object 101 should be set to W_{image}/m or more. In the following description, the beam diameter on the object 101 is W_{image}/m.

A position of the beam waist and the beam diameter at the beam waist can be converted by causing the laser beam to pass through a lens. When w₁ and w₂ respectively represent beam widths (each corresponding to a 1/e² radius) of the beam waist before and after passage through the lens, d₁ and d₂ respectively represent distances from the beam waist before and after the passage through the lens to the lens, f represents a focal length of the lens and λ represents a wavelength of the laser, the following relations expressed by expression (4) are established:

w²=w₁²·f²[(f−d₁)²+(π·w₁²/λ)²]

d₂=f+(w₂/w₁)²·(d₁−f) (4).

In addition, when w(z) represents a beam diameter at a position away from the beam waist of the laser beam whose beam waist width is wₒ by a distance z, R(z) represents a curvature radius of a beam wavefront at that position and θ_{wo} represents a beam divergence angle at a position sufficiently away from the beam waist, the following relations expressed by expressions (5) and (6) are established:

w(z)²=wₒ²{1+[z·λ/(π·wₒ²)]²}

R(z)=z·{1+[π·wₒ²/(z·λ)]²} (5)

θ_{wo}=λ/(π·wₒ) (6)

When the laser beam enters the lens with the beam waist being located at a front focal point of the lens, which corresponds to d₁=f, the second expression of expressions (4) provides d₂=f. Therefore, it is understood that the position of the beam waist after passage of the lens coincides with a rear focal point of the lens. Moreover, it is understood that, from transformation of the first expression of expression (4) by setting of d₁=f, the following relation is established:

w₁·w₂=f·λ/π.

Accordingly, in order to set the beam diameter at the beam waist on the object 101 to W_{obj}, it is necessary that, when W_{obj-front} represents a beam diameter at a beam waist formed at a front focal position of the objective lens 102-A, the following relation be satisfied:

W_{obj-front}=f_{obj}/·λ/(π·W_{obj}).

Similarly, a beam diameter Wₚₒᵣₜ₂ at a beam waist formed at the second camera port 212 is defined as follows:

Wₚₒᵣₜ₂=f_{tube}·λ/(π·W_{obj-front}).

Substituting f_{obj}/·λ/(π·W_{obj}) to W_{obj-front} in the above expression provides the following relation:

$$\begin{matrix}{W}_{port 2} = {f}_{tube} \cdot λ / ( Π \cdot {f}_{obj} \cdot λ / ( Π \cdot {W}_{obj} ) ) \\ = {W}_{obj} \cdot {f}_{tube} / {f}_{obj} \\ = {W}_{obj} \cdot m \\ = {W}_{image}\end{matrix}$$

As described above, on the basis of the illumination area necessary on the object plane 101, the beam diameter that should be obtained at each beam waist for realizing the illumination area can be decided by using expression (4). As understood from the above expression, changing the imaging magnification m does not cause a variation of the beam diameter Wₚₒᵣₜ₂ in the second camera port 212.

A more detailed description of propagation of the beam waist will be made. The laser beam 301 has a certain beam diameter of the beam waist (the beam diameter of the beam waist is hereinafter referred to as “a beam waist diameter”) at a beam emitting portion of the laser source 111. Laser sources respectively have different unique beam waist diameters and different unique beam divergence angles. Relations among the beam waist diameter, the wavefront and the beam divergence angle are decided by expressions (4) to (6) described above.

In other words, in a case where the beam waist diameter is in a submillimeter to millimeter range like those of a lot of gas lasers, the beam divergence angle in a visible wavelength region is in a milliradian range whereas beam diameters of most semiconductor lasers are in a micrometer range and the beam divergence angles thereof are in a range from several ten to several hundred milliradian.

The configuration shown in FIG. 18 is suitable for a case where the laser source 111 emits a laser beam having a relatively large beam diameter and relatively small divergence angle at its beam emitting portion like the gas lasers. The laser beam 301 emitted from the laser source 111 passes through the first optical path length adjuster 410 where a predetermined optical path length is provided and then collected by the condenser lens 401 to form a beam waist near a focal point of the condenser lens 401 according to the above-mentioned expression (4). Moreover, the laser beam 301 passes through the collimator lens 402 to form a beam waist at the in-camera port conjugate plane of the second camera port 212. Regarding focal lengths of the condenser lens 401 and collimator lens 402 and a distance therebetween, adjustment thereof is necessary such that the beam waist diameter at the in-camera port conjugate plane of the second camera port 212 becomes Wₚₒᵣₜ₂ mentioned above. This adjustment can be made by translating the bending mirrors 412 and 413 in the first optical path length adjuster 410 to change the optical path length. Similarly, an appropriate adjustment of the optical path length is made by translating the bending mirrors 422 and 423 in the second optical path length adjuster 420.

As described above, since changing the focal length of the objective lens 102-A to change the imaging magnification does not need changing the beam waist diameter at the second camera port 212, the focal lengths of the condenser lens 401 and collimator lens 402, the distance therebetween and the optical path, which are described above, are not necessary to be changed after once setting them.

However, in a case where the wavelength of the excitation light or the beam diameter at the beam emitting portion of the light source is changed corresponding to, for example, a change of kind of fluorescent dye to dye the sample, it is necessary to reset the focal lengths of the condenser lens 401 and collimator lens 402, the distance therebetween and to readjust the first and second optical path length adjusters 410 and 420. In order to perform such resetting and readjustment, it is desirable that the collimator lens 402 be a focal length changeable lens and the condenser lens 401 be movable in its optical axis direction.

In a case where the beam diameter of the beam emitting portion of the light source is small and the beam divergence angle thereat is relatively large like semiconductor lasers, the beam waist formed at a position of the condenser lens 401 shown in FIG. 18 can be regarded as a beam emitting portion of the semiconductor laser, and thereby using the configuration subsequent to the collimator lens 402 without change can similarly set the beam waist. Also in a case where the laser beam is introduced by an optical fiber, an exit end of the optical fiber can be regarded as the beam waist formed at the position of the condenser lens 401 and IN when it is small and the divergence angle is comparatively large as the light emitting member of the semiconductor laser, and thereby the configuration subsequent to the collimator lens 402 can be used without change.

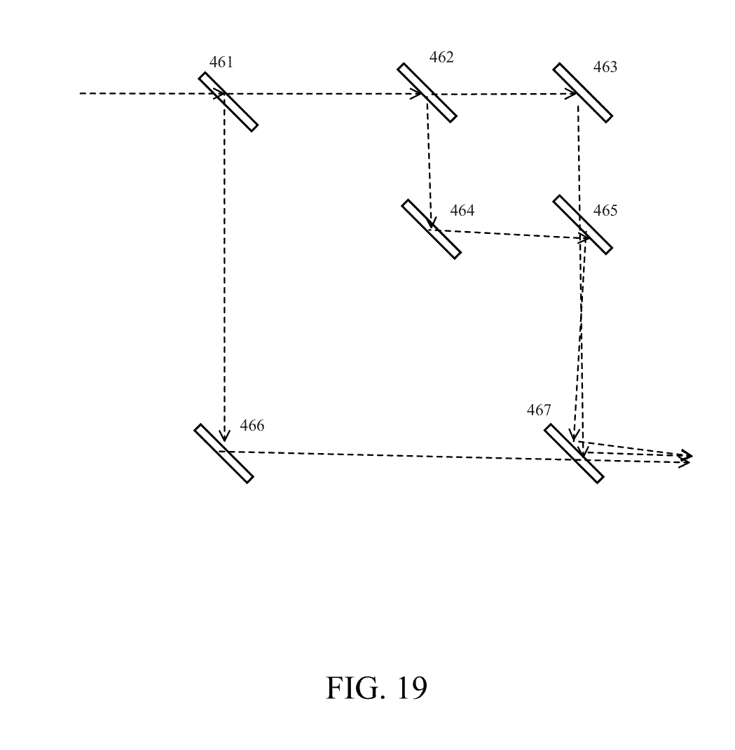

In a case of using three laser beams, a tri-branching optical system shown in FIG. 19 can be used instead of the Mach-Zehnder interferometer 430 shown in FIG. 18. In FIG. 19, reference numeral 461 denotes a half mirror that divides an entering light beam into a reflected light beam having an intensity ratio of 1/3 and a transmitted light beam having an intensity ratio of 2/3. Reference numerals 462, 465 and 467 denote general half mirrors, and reference numerals 463, 464 and 466 denote bending mirrors.

Returning to FIG. 18, description will be made of the modifications of the general fluorescence microscope necessary to install the illumination unit. First, the excitation light filter 201, the dichroic mirror 114 and the fluorescent light filter 203 shown in FIG. 17 are removed by rotating the turret. Next, the fluorescent light filter 203 or a filter having an optical property equivalent to that of the fluorescent light filter 203 is disposed between the half mirror 204 and the first camera port 211. The filter 203 (or the filter equivalent thereto) blocks the reflected light 303 which is the laser beams (excitation light) 301-A and 301-B reflected by the object 101 to prevent the reflected light 303 from entering the image sensor 103. The fluorescent light filter 203 may be disposed in front of the image sensor 103. This modification is only to change a position of the fluorescent light filter 203, which is easily performed and facilitates restoration to the original state.

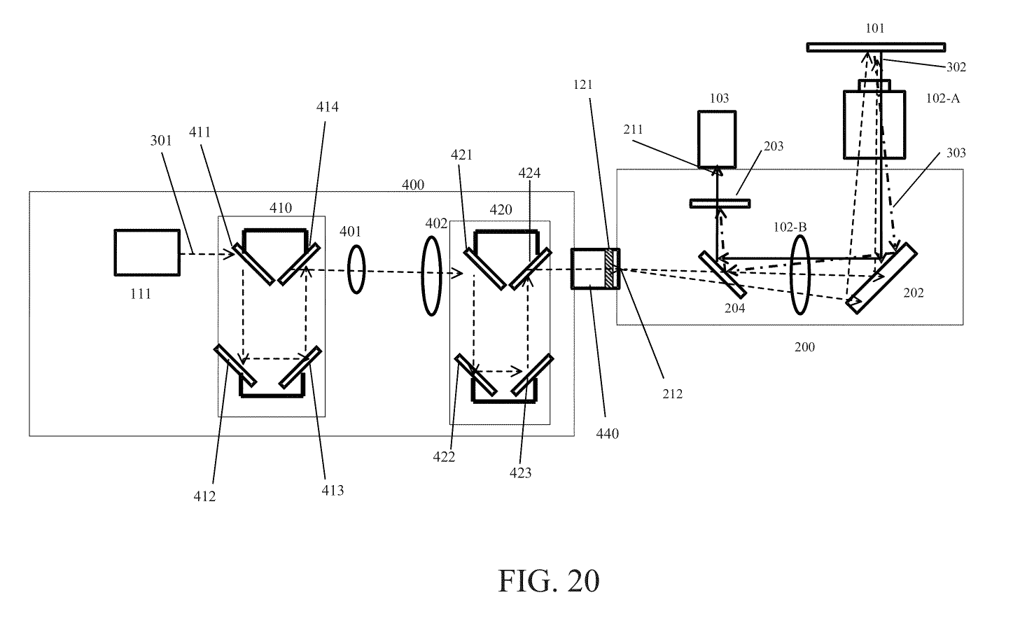

Next, description will be made of another configuration to provide the multiple light beams with reference to FIG. 20. FIG. 20 shows a configuration where a diffraction grating 112 divides the light beam. In the following description, different parts from the configuration using the Mach-Zehnder interferometer 430 shown in FIG. 18 are mainly described, and common parts are simply described or description thereof is omitted.

The illumination unit 400 forms the beam waist at the in-camera port conjugate plane in the second camera port 212 as in the configuration shown in FIG. 18. However, in this configuration, the diffraction grating 112 disposed in front of the second camera port 212 divides the laser beam 301 into the two laser beams 301-A and 301-B. The diffraction grating 112 is constituted by, for example, a gradient index diffraction grating having a certain thickness. In the gradient index diffraction grating having the certain thickness, a refractive index in this element three-dimensionally changes. It is known that optimizing the distribution of the refractive index of the gradient index diffraction grating makes it possible to equally divide most of intensity of entering light to those of a zeroth-order diffracted light and a first-order diffracted light and to reduce energy distributed to diffracted lights of other diffraction orders such as a minus first order. A diffraction angle of the first-order diffracted light can be adjusted by setting of a pitch of the distribution of the refractive index.

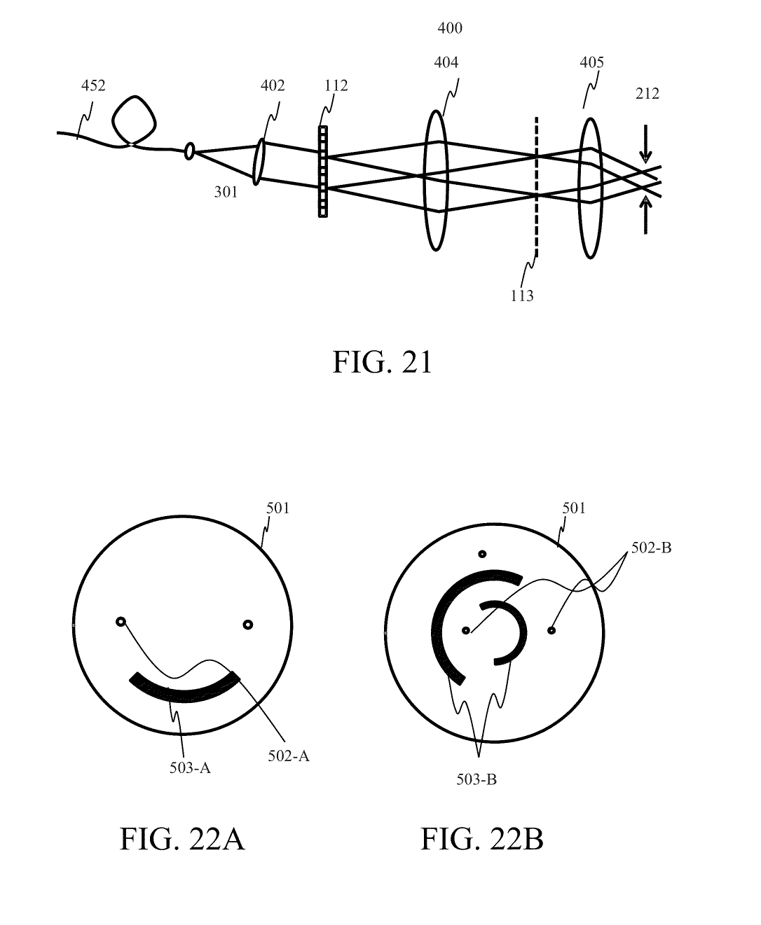

Division of the light beam emitted from the light source into the multiple light beams to cause them to enter the second camera port 212 is possible by other configurations. Although a configuration shown in FIG. 21 also uses a diffraction grating 112 as a light beam divider, this configuration is different from that shown in FIG. 20. A laser beam emitted form a laser source (not shown) passes through a condenser lens (not shown) and enters am optical fiber 452 to be introduced to an illumination unit 400. The laser beam 301 diverges from an exit end of the optical fiber 452 is approximately collimated by a first collimator lens 402. The collimated beam enters the diffraction grating 112 to be divided into a zeroth-order diffracted beam and a first-order diffracted beam. The two diffracted beams are collected by a condenser lens 404 to a focal plane 113 thereof (in other words, a pupil plane of an illumination optical system constituting the illumination unit 400), pass through a second collimator lens 405 to respectively form beam waists and then enter the general fluorescence microscope 200 from the second camera port 212.

At the pupil plane 113 of the illumination optical system, the two diffracted beams are collected at mutually different positions respectively corresponding to their incident angles on the second camera port 212.

The optical system constituted by the condenser lens 404 and the second collimator lens 405 can set a conjugate relation of the diffraction grating 112 and the second camera port 212. This setting can cause the two divided diffracted beams to overlap each other at the second camera port 212. Moreover, setting an incident angle of the collimated light on the diffraction grating 112 to an angle not equal to 0 clearly makes it possible to realize the asymmetric structure illumination on the object 101.

Next, a method for realizing the uniform illumination will be described. The uniform illumination can be realized by using the epi-illumination optical system originally provided with the general fluorescence microscope. However, constructing a three-dimensional image needs multiple sectioning images captured with step by step changes of the focus coordinate. Capturing such multiple sectioning images requires frequent switching between the asymmetric structure illumination and the uniform illumination. If removal of the illumination unit and restoration of the fluorescence microscope to the original state with installation of the epi-illumination optical system is performed at each switching, it is disadvantageous timewise. Moreover, frequent operation of the turret holding the optical elements such as the filter and the dichroic mirror and replacement of these optical elements may cause unnecessary vibration or image displacement.

Therefore, it is not realistic to remove a selective illumination unit to restore the microscope to the original state and thereby realize the uniform illumination. Thus, possible alternative methods are, for example, a method (first method) that blocks, of multiple light beams, other light beams than one light beam and thereby illuminates the object with the one light beam and a method (second method) that utilizes a degree of freedom of a polarized light beam so as to prevent the multiple light beams from interfering with one another. The first method can be realized by disposing a light-blocking member to block the laser beam 301-A shown in FIG. 18 between the half mirror 431 and the bending mirror 433. The light-blocking member can be used with a drive mechanism that repeats insertion and removal of the light-blocking member at each timing of switching between the asymmetric structure illumination and the uniform illumination. The second method is suitable for a case where a linearly polarized light beam is used. For example, rotating a polarization direction of one of two light beams divided by a polarization element such as a half-wave plate by 90 degrees with respect to a polarization direction of the other light beam prevents these two light beams from interfering with each other, which enables realization of the uniform illumination. The methods for realizing the uniform illumination will be described in detail below.

Using the above-described methods enables, by providing a modification that is simple and restorable to the original state to the general fluorescent microscope and by installing the illumination unit, construction of a three-dimensional fluorescence microscope system having a high-quality sectioning effect. A pattern displacement of the asymmetric structure illumination does not influence final image quality as long as the pattern has periodicity. This is because, although computer processing for providing the sectioning effect requires standard deviation values calculated in areas near respective points in the image, the area near each point of the image is larger than one period of the pattern.

Next, a detailed description of the fluorescence microscopes provided with the illumination optical system having the pupil function P2 will be made in Embodiments 1 and 2, and a description of specific configurations of the illumination unit will be made in Embodiments 3 to 5.

### Example 1

A microscope illumination optical system that is in Embodiment 1 (Example 1) has a configuration as shown in FIG. 11 and has, as optical parameters, a wavelength λ of 500 nm and an NA of 0.7. This microscope illumination optical system illuminates the object O2. The pupil function P2 of the illumination optical system corresponds to mutually coherent point light sources expressed by coordinates (A) or three vertices of a triangle similar to a triangle formed by the three points as shown in FIG. 9A. In this embodiment, a and b in coordinates (A) are a=0.2 and b=0.1.

A comparison is made of the method using the random speckle illumination disclosed in NPL 5 and NPL 6 and the method using the lattice illumination formed by the illumination optical system of this embodiment having the pupil function P2.

FIGS. 12A and 12B show an image of the object O2 obtained by the method using the random speckle illumination. FIG. 12A shows an x-z plane (section) when the image is cut along a plane of y=0 μm. Image components appear at positions of z=±1 μm where the fluorescent object should originally exist, but their intensity distribution is not uniform. FIG. 12B shows a sectional image on an x-y plane at the position of z=1 μm, from which it is understood that illumination unevenness is wholly large. FIG. 12C shows intensity in a section cut along a straight line passing through a position of x=y=0 μm. The intensity is asymmetric in a direction of z and only has a contrast of about 0.4. FIG. 12D shows intensity on a straight line passing through a position of y=0 μm and z=1 μm; the intensity is non-uniform.

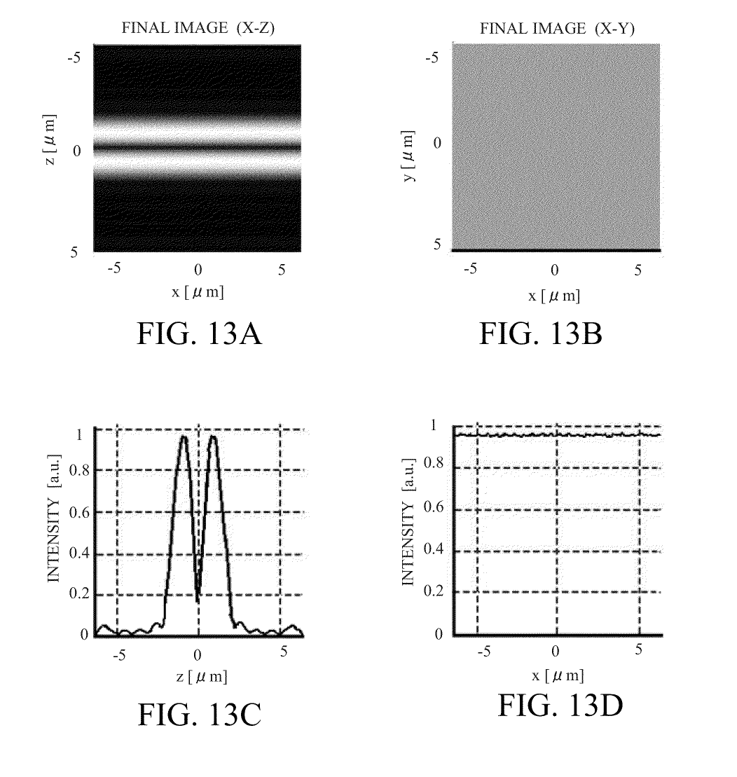

On the other hand, FIGS. 13A and 13B show an image of the object O2 obtained by the method using the lattice illumination formed by the illumination optical system of this embodiment having the pupil function P2. FIG. 13A shows an x-z plane (section) when the image is cut along a plane of y=0 μm. Image components appear at positions of z=±1 μm where the fluorescent objects should originally exist, and their intensity distributions are approximately uniform. FIG. 13B shows a sectional image on an x-y plane at a position of z=1 μm, from which it is understood that illumination unevenness is wholly suppressed to a low level. FIG. 13C shows intensity in a section cut along a straight line passing through a position of x=y=0 μm. The intensity is symmetric in a direction of z and has a sufficient contrast of 0.7 or more. FIG. 13D shows intensity on a straight line passing through a position of y=0 μm and z=1 μm; the intensity is approximately uniform.

### Example 2

Although Embodiment 1 described the case of providing three point light sources in the pupil of the illumination optical system, the number of the point light sources is not limited to three, and may be two or four or more. Embodiment 2 (Example 2) describes an illumination optical system that uses two point light sources to provide the sectioning effect.

FIG. 14A shows a pupil function of the illumination optical system of this embodiment. Coordinates of the two point light sources on the pupil surface are (0, 0.9) and (0, −0.5). FIG. 14B shows an illumination light intensity distribution formed by the pupil function on the object plane. Such a pupil function can be easily formed by dividing a point light source as the coherent light source 111 into two by using a diffraction grating or the like as the optical element 112 shown in FIG. 11. As a result, a stripe pattern is generated on the object plane by two-beam interference.

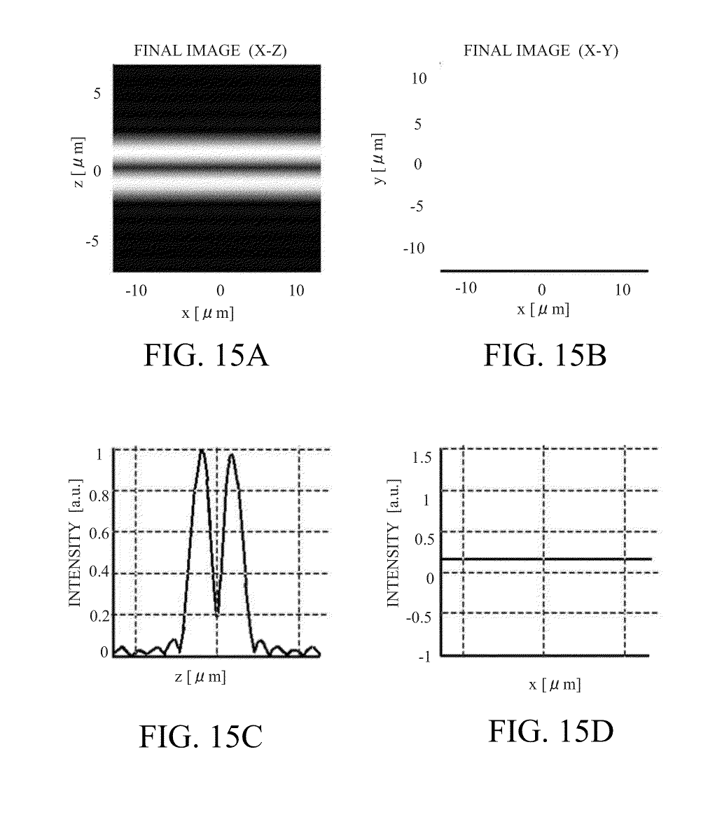

FIGS. 15A and 15B show an image of the object O2 obtained by the method using the lattice illumination formed by the illumination optical system of this embodiment having the pupil function including the two point light sources. FIG. 15A shows an x-z plane (section) when the image is cut along a plane of y=0 μm. Image components appear at positions of z=±1 μm where the fluorescent object should originally exist, and their intensity distribution is approximately uniform. FIG. 15B shows a sectional image on an x-y plane at the position of z=1 μm, from which it is understood that illumination unevenness is wholly suppressed to a low level. FIG. 15C shows intensity in a section cut along a straight line passing through a position of x=y=0 The intensity is symmetric in a direction of z and has a sufficient contrast of 0.7 or more. FIG. 15D shows intensity on a straight line passing through a position of y=0 μm and z=1 μm; the intensity is approximately uniform.

As described above, the number of light source areas may be any multiple number (two or more).

In experiments performed by the inventor in which image capturing is performed by a three-dimensional microscope using the illumination optical system described in each of Embodiments 1 and 2 with a pixel number of 256×256×256, a time required for the process by a workstation equipped with a CPU of 3.33 GHz was within one minute. Providing a dedicated computer program, a parallel distribution environment and optimized hardware such as a graphic accelerator sufficiently enables acquisition of an image within a time shorter than that required for scanning by a confocal microscope.

### Example 3

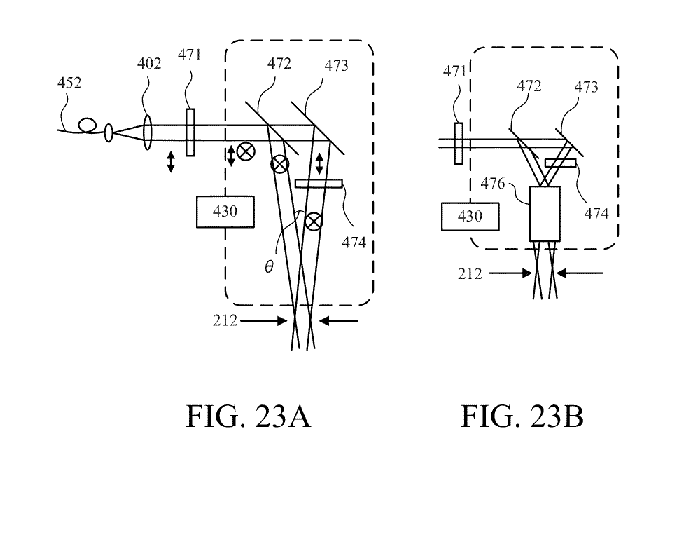

Embodiment 3 (Example 3) presents a numerical example relating to settings of the illumination area, the beam waist and the beam diameter by using the following specific numerical values (predetermined values) such as an imaging magnification of the microscope and thereby shows that the configuration shown in FIG. 22 is actually realizable.

A half length of a diagonal length of the image sensor 103: W_{image}=4 mm

A focal length of the objective lens 102-A: F_{obj}=4 mm

A focal length of the imaging lens 102-B: F_{tube}=160 mm

An imaging magnification from the object 101 to the image sensor 103: m=40×

A wavelength of the laser source 101: λ=488 nm

A focal length of the condenser lens 401: F1=15 mm

A radius of the beam emitting portion of the laser source 111: Wo=0.26 mm

In Table 1, a unit of optical parameters except the wavelength of the laser source 101 is mm. From the given predetermined values (shown in an upper part of Table 1), the optical parameters other than the predetermined values are calculated. The calculated parameters listed below are collectively shown in a lower part of Table 1, which are realistic values.

An optical path length from the beam emitting portion of the laser source 111 via the first optical path length adjuster 410 to the condenser lens 401: D₀

A beam diameter of beam waist formed near the focal point of the condenser lens 401: W₁

A variable focal length of the collimator lens 402: F₂

A distance between the condenser lens 401 and the beam waist formed near the focal point of the condenser lens 401: D₁

A distance between the beam waist formed near the focal point of the condenser lens 401 and the collimator lens 402: D₂

An optical path length from the collimator lens 402 via the second optical path length adjuster 420 and the Mach-Zehnder system 430 to the in-camera port conjugate plane in the second camera port 212 D₃

A beam diameter of the beam waist formed at the in-camera port conjugate plane in the second camera port 212: Wₚₒᵣₜ₂

When setting the distance d₂ between the condenser 401 and the collimator lens 402 to 98.7754 mm+15.2 mm, adjusting the optical path length d₀ from the beam emitting portion of the laser source 111 via the first optical path length adjuster 410 to the condenser lens 401 to 933.898 mm provides an illumination area illuminated by the asymmetric structure illumination as an area having a width of W_{image}=4 mm as assumption.

The connection portion shown in FIG. 22 between the illumination unit 400 and the second camera port 212 generally uses a C mount or a T mount, each being a general mount. For example, when using the C mount, an installation error in a direction orthogonal to the optical axis is approximately ±0.1 mm. In this embodiment, the illumination area illuminated by the asymmetric structure illumination is set to W_{image}=4 mm; an installation error with respect thereto is approximately 2.5%. The installation error of the C mount in the direction orthogonal to the optical axis causes a horizontal displacement between an area of the object 101 which is captured by the image sensor 103 and the illumination area illuminated by the asymmetric structure illumination. However, an illumination defect occurring in an outer area of the image corresponding to approximate 2.5% thereof does not generally become a problem. On the other hand, an error (displacement) in the optical axis direction may occur when coupling of the mount. Assuming that the displacement in the optical axis direction is approximately ±0.1 mm, a displacement between the object plane corresponding to a focal point of the objective lens 102-A and the beam waist formed thereat is calculated as about 63 nm. This value is smaller than a depth of focus of the objective lens 102-A, which is ignorable.

TABLE 1

| | |
|---|---|
| Wimage | 4 |
| fobj | 4 |
| ftube | 160 |
| m | 40 |
| wO | 0.26 |
| f1 | 15 |
| λ (nm) | 488 |
| Wobj | 0.1 |
| Wobj-front | 0.6213 |
| Wport2 | 4 |
| d3 | 500 |
| f2 | 98.775 |
| d2 | 98.7754 |
| d1 | 15.2 |
| w1 | 0.003836 |
| d0 | 933.898 |

### Example 4

Embodiment 4 (Example 4) shows a method that uses one of the multiple light beams used for the asymmetric structure illumination and blocks the other light beams in the configuration shown in FIG. 18, which results in illumination using only the one light beam. In this embodiment, description will be made with reference to FIG. 21. The multiple light beams produced by the diffraction grating 112 is collected by the condenser lens 404 onto the pupil 113 of the illumination optical system to form multiple spots. The pupil 113 of the illumination optical system has a conjugate relation with a pupil of the objective lens 102-A. Thus, disposing a light-blocking mask 501 shown in FIGS. 22A and 22B at the pupil 113 of the illumination optical system or near a position conjugate therewith enables control of light transmittance of the multiple spots.

FIG. 22A shows an exemplary structure of the light-blocking mask 501 suitable for a case where the multiple light beams are two light beams, and FIG. 22B shows an exemplary structure of the light-blocking mask 501 suitable for a case where the multiple light beams are three light beams.

In FIGS. 22A and 22B, of the multiple spots, blocking target spots are denoted by 502-A and 502-B. Moving light-blocking portions 503-A and 503-B provided in part of the light-blocking mask 501 enables blocking the blocking target spots 502-A and 502-B. Providing such a light-blocking mask 501 allows only one light beam corresponding to the remaining one spot to be projected onto the object plane, which enables the uniform illumination. The light-blocking portions 503-A and 503-B can be easily moved by rotating the light-blocking mask 501 having a disc-like shape about the optical axis. When it becomes necessary to perform the asymmetric structure illumination again, it is only necessary to move the light-blocking mask 501 so as to return to the state where the multiple light beams are not blocked.

The light-blocking portion may be moved by other movement ways than the rotation about the optical axis, as long as the above-mentioned light-blocking function can be provided. For example, the light-blocking mask 501 may be slided so as to be inserted into and removed from the optical path. Moreover, the light-blocking mask 501 may be driven by any driving methods. Providing a lot of the light-blocking portions 503 whose each area is small on the light-blocking mask 501 makes it possible to switch between the asymmetric structure illumination and the uniform illumination only by a slight movement of the light-blocking mask 501.

The light-blocking portion 503 can be realized by using a material having an extremely low transmittance for a general light or by using a polarization element that selectively blocks a light in a specific polarization state. Moreover, using a liquid crystal polarizing plate or the like that is capable of dynamically changing its property such as transmittance as the light-blocking portions 503 eliminates even the necessity of the movement of the light-blocking mask 501.

### Example 5

This embodiment shows an exemplary configuration of an optical system that includes a branching portion to divide a light beam into multiple light beams and controls a polarization state of each light beam so as to perform switching of the asymmetric structure illumination and the uniform illumination. FIGS. 23A and 23B show such configurations. Since the configuration shown in FIG. 23A is similar to that shown in FIG. 21 in many points, description of an optical path configuration from the light source to the second camera port 212 is only made, and description of common components is omitted. Light emitted from the light source (not shown) passes through the optical fiber 452 to be introduced to the collimator lens 402. The light is collimated by the collimator lens 402. The light source in this embodiment is a coherent light source, and the light emitted therefrom is a linearly polarized light whose polarization direction is perpendicular to the paper of FIG. 23. A polarization forming element 471 is, for example, a half-wave plate. The half-wave plate is disposed such that its optic axis is tilted by 45 degrees with respect to the polarization direction of the collimated light, which divides the collimated light into a linearly polarized light component (s-wave) whose polarization direction is perpendicular to the paper of FIG. 23 and a linearly polarized light component (p-wave) whose polarization direction is a depth direction to the paper of FIG. 23.

Next, description will be made of a configuration of a beam interference optical system 430 constituted by elements 472, 473 and 474. The s-wave is reflected by a polarization beam splitter 472. On the other hand, the p-wave is transmitted through a polarization beam splitter 472. The s-wave reflected by the polarization beam splitter 472 directly proceeds to the second camera port 212. The p-wave transmitted through the polarization beam splitter 472 is reflected by a bending mirror 473 and thereby changes its proceeding direction. The p-wave changing the proceeding direction is converted, by a half-wave plate 474 whose optic axis is orthogonal to an optical axis and is tilted by 45 degrees with respect to a polarization direction of the p-wave, into an s-wave. Then, the s-wave reaches the second camera port 212. The two s-waves reaching the second camera port 212 have coherence at the second camera port 212 and the object 101 and thereby form the asymmetric structure illumination.

On the other hand, in order to realize the uniform illumination, a setting is made such that the polarized light components after passage through the polarization forming element 471 are only the s-wave or only the p-wave. This setting causes only the s-wave or only the p-wave to reach the second camera port 212, which makes it possible to form the uniform illumination. Although FIG. 23A exemplary showed the case where the asymmetric structure illumination is produced by two-beam interference, adding a beam branching portion utilizing polarization makes it possible to generate interference of three or more light beam to produce the asymmetric structure illumination. Furthermore, appropriate addition of a polarizing element to optical paths of the multiple light beams from the beam branching portion to the second camera port 212 to adjust polarization states of the light beams can be arbitrarily made.

A sine of an angle θ between the two light beams shown in FIG. 23A is inversely proportional to a lateral magnification β of the in-camera port conjugate plane in the second camera port 212 to the object 101. More specifically, when NA represents a numerical aperture of the objective lens 102-A, r represents a pupil radius corresponding to the NA, n represents a refractive index of a medium of a sample surface and d represents a distance between the spots in the pupil 113 of the illumination optical system, the sine of the angle θ is expressed by expression (7):

$$sin θ = \frac{dNA}{rn β} \qquad ( 7 )$$

For example, when NA=0.95, d/r=1 and β=40, sin θ=0.024, which is significantly small. In order to ensure a distance of, for example, 5 cm between the polarization beam splitter 472 and the bending mirror 473 for preventing interference thereof, a distance of approximately 2 cm is necessary between these two elements and the in-camera port conjugate plane in the second camera port 212, which increases size of the illumination unit. In order to solve this problem, as shown in FIG. 23B, a beam expander (magnification mₑₓₚ) 476 can be inserted in the beam interference optics system 430 to expand the angle formed by the two light beams mₑₓₚ times. This makes it possible to configure an illumination unit having a practicable size.

The embodiments described above are merely typical examples, and in the practice of the present invention, various modifications and changes can be made for each embodiment.

This application claims the benefit of Japanese Patent Application Nos. 2012-188223, filed on Aug. 29, 2012 and 2013-174742, filed on Aug. 26, 2013, which are hereby incorporated by reference herein in their entirety.

### INDUSTRIAL APPLICABILITY

Provided is an illumination optical system capable of being used for microscopes such as a fluorescence microscope and a digital slide scanner.

1. An illumination optical system configured to illuminate a sample placed on an object plane with light, the illumination optical system comprising:
multiple light source areas which are mutually coherent and arranged separately from one another in a pupil plane of the illumination optical system,
wherein, among distances from a center of a pupil of the illumination optical system to centers of the multiple light source areas, at least one of the distances is different from the other distances.

2. An illumination optical system according to claim 1, wherein the sample is an autoluminescent.

3. An illumination optical system according to claim 1, wherein a luminescence mechanism of the sample, which is the autoluminescent, is fluorescence or phosphorescence.

4. A microscope comprising:
an illumination optical system configured to illuminate a sample placed on an object plane with light; and
a projection optical system configured to form an image of the sample,
wherein the illumination optical system comprising:
an optical element configured to form multiple light source areas which are mutually coherent and arranged separately from one another in a pupil plane of the illumination optical system,
wherein, among distances from a center of a pupil of the illumination optical system to centers of the multiple light source areas, at least one of the distances is different from the other distances.

5. A microscope according to claim 4, further comprising:
a first camera port and a second camera port disposed at positions each optically conjugate with the object plane,
wherein the first camera port includes an image sensor to perform image capturing of the sample, and
wherein the second camera port configured to receive multiple collimated light beams which are mutually coherent to form the mutually coherent light source areas in the pupil plane of the illumination optical system, a ratio of a size of each light source area to a radius of the pupil of the illumination optical system being smaller than 0.3.

6. A microscope according to claim 5, wherein the second camera port causes the mutually coherent collimated light beams to reach the object plane with incident angles such that the mutually coherent collimated light beams each form a beam waist and mutually overlap at the position optically conjugate with the object plane.

7. A microscope according to claim 5, further comprising an optical element configured to block an excitation light and transmit fluorescence or phosphorescence and disposed between the first camera port and a branching point of an optical path from the object plane to the second camera port and an optical path from the object plane to the first camera port.

8. A microscope according to claim 5, further comprising a movable light-blocking element configured to be switchable between a state of blocking at least one of the mutually coherent collimated light beams and a state of passing through all of them the at least one collimated light beam.

9. A microscope according to claim 8, wherein the light-blocking element has a function of blocking fluorescence or phosphorescence from a sample.

10. A microscope according to claim 8, wherein the light-blocking element includes at least one polarizer.

11. A microscope according to claim 5, further comprising a control mechanism configured to control coherence of the mutually coherent collimated light beams.

12. A microscope according to claim 10, further comprising a control mechanism configured to control polarization directions of the mutually coherent collimated light beams, the control mechanism including at least one polarizer.

13. A microscope according to claim 5, wherein the microscope is a fluorescence microscope.

14. A microscope according to claim 5, wherein the microscope is an epi-illumination microscope or a transmission microscope.

15. A microscope according to claim 6, further comprising an optical element configured to block an excitation light and transmit fluorescence or phosphorescence and disposed between the first camera port and a branching point of an optical path from the object plane to the second camera port and an optical path from the object plane to the first camera port.

16. A microscope according to claim 6, further comprising a movable light-blocking element configured to be switchable between a state of blocking at least one of the mutually coherent collimated light beams and a state of passing through all of them the at least one collimated light beam.

17. A microscope according to claim 16, wherein the light-blocking element has a function of blocking fluorescence or phosphorescence from a sample.

18. A microscope according to claim 7, further comprising a movable light-blocking element configured to be switchable between a state of blocking at least one of the mutually coherent collimated light beams and a state of passing through all of them the at least one collimated light beam.

19. A microscope according to claim 9, wherein the light-blocking element includes at least one polarizer.

20. A microscope according to claim 6, further comprising a control mechanism configured to control coherence of the mutually coherent collimated light beams.
